(19) United States
(12) Patent Application Publication
(10) Pub. No.: US 2007/0041325 A1
(43) Pub. Date: Feb. 22, 2007

(54) Communication method and apparatus using forward differential DRC in a multi-frequency mobile communication system

(76) Inventors: Jung-Soo Jung, Seongnam-si (KR); Dae-Gyun Kim, Seongnam-si (KR); Beom-Sik Bae, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/504,777

(22) Filed: Aug. 16, 2006

(30) Foreign Application Priority Data
Aug. 16, 2005 (KR) 2005-75009

(51) Int. Cl. H04J 1/16; H04Q 7/00

(52) U.S. Cl. 370/235; 370/329

(57) ABSTRACT

A method and apparatus for transmitting a forward differential DRC in an MS which transmits and receives packets in a multi-frequency mobile communication system are provided. The MS transmits full DRCs for allocated forward channels in a division multiplexing scheme and transmits differential DRCs supportable for the forward channels in the division multiplexing scheme.

### PRIORITY

This application claims the benefit under 35 U.S.C. § 119(a) of Korean Patent Application filed in the Korean Intellectual Property Office on Aug. 16, 2005 and assigned Serial No. 2005-75009, the entire disclosure of which is hereby incorporated by reference.

### BACKGROUND OF THE INVENTION

1. Field of the Invention

The present invention relates generally to a method and apparatus for transmitting packet data in a mobile communication system. More particularly, the present invention relates to a method and apparatus for controlling the data rate of a forward packet data to be received in a Mobile Station (MS).

2. Description of the Related Art

Recently, High-speed data transmission in a Code Division Multiple Access (CDMA) mobile communication system has become an active area of study. A major mobile communication system comprising a channel structure supporting high-speed data transmission is 1×EVolution Data Only (1×EV-DO). 1×EV-DO was standardized by the 3rd Generation Partnership Project 2 (3GPP2) to enhance data communication in an Interim Standards-2000 (IS-2000) system.

The forward channel structure of the 1×EV-DO system includes a pilot channel, a forward Medium Access Control (MAC) channel, a forward traffic channel and a forward control channel. These forward channels are sent in Time Division Multiplexing (TDM). A group of the TDM signals is called a burst.

The forward traffic channel delivers a user data packet and the forward control channel carries a control message and a user data packet. The forward MAC channel is used to send reverse rate control and power control information or a channel designated for forward data transmission.

Unlike the forward channels, 1×EV-DO reverse channels comprise Access Terminal (AT)-specific Identifiers (IDs). For each AT, there is a pilot channel, a reverse traffic channel, an access channel, and a Data Rate Control (DRC) channel, and a Reverse Rate Indicator (RRI) channel. The reverse traffic channel sends a user data packet and the DRC channel indicates a forward data rate that the AT can support. The RRI channel is used to indicate the data rate of a reverse data channel. The access channel delivers a message or traffic from the AT to an Access Node (AN) before a traffic channel is established. The configuration of the 1×EV-DO system, and a rate control operation and channels associated with the rate control in the 1×EV-DO system will be described with reference to FIG. 1.

FIG. 1 illustrates the network configuration of a typical 1×EV-DO system.

Referring to FIG. 1, the 1×EV-DO system is comprised of a Packet Data Service Node (PDSN) 140 connected to an Internet 150 and an Access Node Controller (ANC) 130. The PDSN 140 sends sending high-speed packet data to an AN 120 and the ANC 130 controls the AN 120. The AN 120 wirelessly communicates with a plurality of ATs 110 and sends the high-speed packet data to a particular AT 110a.

For rate control of a forward channel, the AT 110 measures the received strength of a pilot signal received from the AN 120 and determines a forward data rate at which the AT 110 is to receive data based on the measurement. The AT 110 sends a DRC indicating the determined forward data rate to the AN 120 on a DRC channel. The AN 120 collects DRCs from ATs and may send packet data to the AT 110a in a good channel condition among the ATs at the data rate reported by the AT 110a.

To meet the demand for higher data rates than those available in legacy communication systems, a multi-carrier EV-DO system has been proposed to achieve higher data rates than the above-described 1×EV-DO system. The multi-carrier EV-DO system allocates a plurality of carriers to one AT, compared to the conventional EV-DO system in which data is transmitted/received on a single carrier. Since each carrier supports the maximum data rate allowed in the conventional EV-DO system, the AT can use as much as a higher maximum data rate as the number of the carriers in an ideal environment.

As with the 1×EV-DO system, an AN schedules data based on DRCs received from ATs in the multi-carrier EV-DO system. Thus, the ATs each generate a DRC based on the received strengths of pilot signals received on a plurality of allocated carriers and send the DRC to the AN. The ATs send as many DRC channels as the number of the allocated carriers. The transmit power of one DRC channel is too high to be negligible in the 1×EV-DO system and the multi-carrier system. Therefore, the power of the ATs is quickly consumed for transmission of the plurality of DRC channels.

Accordingly, there is a need for an improved system and method for controlling the data rate of forward packet data to be received in an MS.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a method and apparatus for controlling the data rate of forward packet data to be received in an MS.

An exemplary embodiment of the present invention also provides a method and apparatus for sending a DRC sufficient amount of times with sufficient accuracy by an MS to solve the power consumption problem and to facilitate a Base Station's (BS) ability to schedule data transmission on each carrier for the MS.

According to one aspect of an exemplary embodiment of the present invention, a method of transmitting a forward differential DRC in an MS in a multi-frequency mobile communication system is provided. The MS transmits full DRCs for allocated forward channels in a division multiplexing scheme and transmits differential DRCs supportable for the forward channels in the division multiplexing scheme.

According to another aspect of an exemplary embodiment of the present invention a method of receiving a forward DRC in a BS in a multi-frequency mobile communication system is provided. The BS determines for every forward channel allocated to a predetermined MS whether a full DRC for the forward channel is to be transmitted in a current slot by the MS, receives a predetermined DRC channel for delivering the full DRC for the forward channel and determines whether the full DRC for the forward channel is to be transmitted in the current slot by the MS. The BS receives a differential DRC for the forward channel from the MS by receiving bits at a predetermined position on a differential DRC channel and verifies the differential DRC.

According to a further aspect of an exemplary embodiment of the present invention, in an apparatus for transmitting a forward differential DRC in an MS in a multi-frequency mobile communication system, a data processor generates a full DRC and a differential DRC for every allocated forward channel. A controller determines whether the full DRC is to be transmitted in a current slot and determines the differential DRC. A transceiver transmits a DRC channel containing the full DRC and the differential DRC for the forward channel to a BS.

According to still another aspect of an exemplary embodiment of the present invention, n an apparatus for receiving a forward differential DRC in a BS in a multi-frequency mobile communication system is provided. A controller determines whether a full DRC is to be transmitted in a current slot by an MS and verifies a received differential DRC. An RF unit receives a DRC channel containing the full DRC and the differential DRC from the MS.

According to yet another aspect of an exemplary embodiment of the present invention, a multi-frequency mobile communication system in which an MS transmits a forward differential DRC is provided. The MS generates a full DRC and a differential DRC for every allocated forward channel, determines whether the full DRC is to be transmitted in a current slot, determines the differential DRC, and transmits a DRC channel containing the full DRC and the differential DRC for the forward channel to a BS. The BS determines whether a full DRC is to be transmitted in the current slot by the MS, verifies a received differential DRC, and receives a DRC channel containing the full DRC and the differential DRC from the MS.

### BRIEF DESCRIPTION OF THE DRAWINGS

The above and other exemplary objects, features and advantages of certain exemplary embodiments of the present invention will be more apparent from the following description taken in conjunction with the accompanying drawings, in which:

FIG. 1 illustrates the network configuration of a typical 1×EV-DO system;

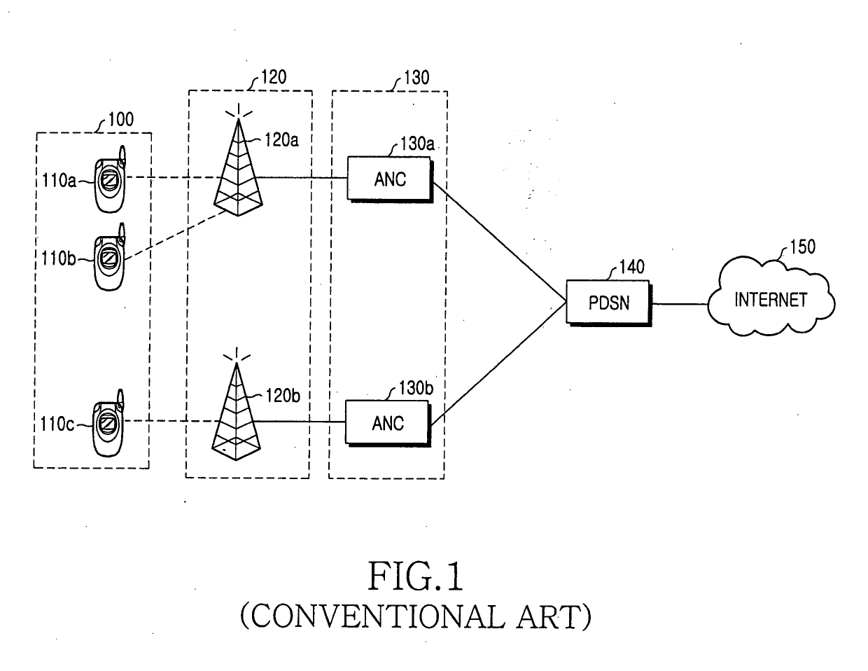

FIG. 2 illustrates transmission of differential DRCs in TDM according to an exemplary embodiment of the present invention;

FIG. 3 illustrates transmission of differential DRCs in Code Division Multiplexing (CDM) according to an exemplary embodiment of the present invention;

FIG. 4 illustrates transmission of differential DRCs in CDM according to another exemplary embodiment of the present invention;

FIG. 5 illustrates reverse DRC channels used when differential DRCs for eight forward channels are sent according to the second exemplary embodiment of the present invention illustrated in FIG. 4;

FIG. 6 is a flowchart illustrating an operation for sending differential DRCs in a slot t in an MS according to an exemplary embodiment of the present invention;

FIG. 7 is a flowchart illustrating an operation for receiving the differential DRCs in slot t from the MS in a BS according to an exemplary embodiment of the present invention; and

FIG. 8 is a block diagram of the MS and the BS according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

An exemplary embodiment of the present invention is intended to provide a method of reducing the size of a DRC sent from an MS and a method of sending a plurality of DRCs for forward channels on one DRC channel in order to solve the existing power consumption problem in a multi-carrier system.

Transmission of Differential DRC

To reduce the size of the DRC, an MS notifies a BS of the state of a forward channel to be received by sending a 4-bit full DRC and a 1-bit differential DRC in combination. This is different from the conventional method of sending a 4-bit forward full DRC in each slot.

For example, the MS sends a 4-bit full DRC in a first slot and a 1-bit or 2-bit differential DRC indicating a rate increase/keep/decrease relative to a data rate in the previous slot in a next slot in every 16 slots.

One way to send the differential DRC is to send full DRCs and differential DRCs for different forward channels on one or more DRC channels in TDM.

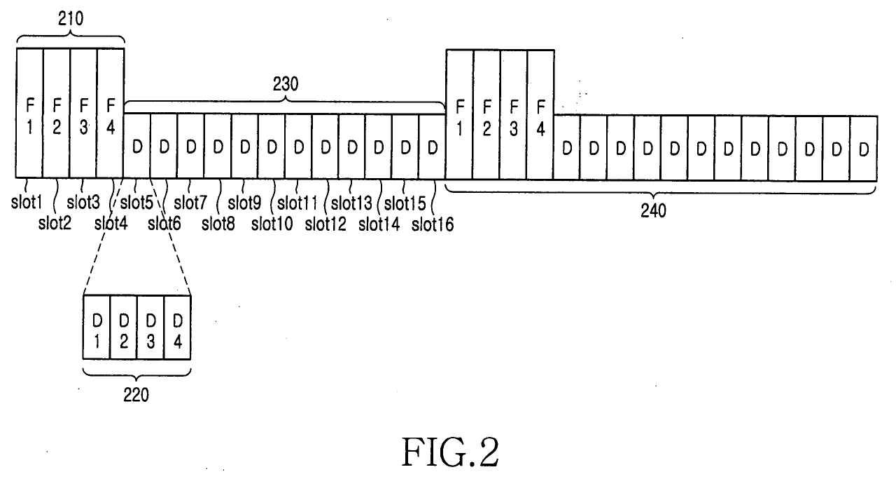

FIG. 2 illustrates transmission of differential DRCs in TDM according to an exemplary embodiment of the present invention.

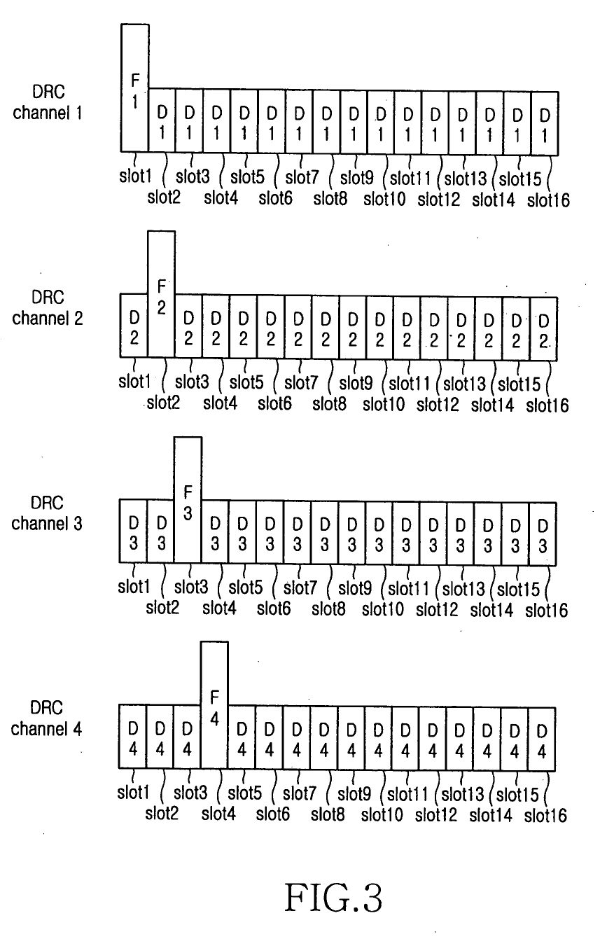

Referring to FIG. 2, F1 to F4 210 denote full DRCs for allocated forward channels (referred to as FAs) FA1 to FA4 and D1 to D4 220 denote differential DRCs for the forward channels FA1 to FA4. As illustrated in FIG. 2, the DRCs for the forward channels FA1 to FA4 are sent on a single reverse DRC channel. In every predetermined period, for example, in every 16 slots, 4-bit full DRCs for FA1 to FA4 are sequentially sent in the first four slots and differential DRCs are sent in the remaining 12 slots 230. A differential DRC is 1-bit information indicating a rate increase or decrease. On the DRC channel, differential DRCs for FA1 to FA4 are delivered in the four bits 220, respectively. Reference numeral 240 denotes a period of 16 slots. In addition to the TDM differential DRC transmission method illustrated in FIG. 2, differential DRCs are sent on a plurality of DRC channels, and each differential DRC is represented in a plurality of bits. Also, differential DRCs can be sent in CDM, such as by distinguishing full DRCs and differential DRCs for different forward channels by different codes and sending them in the manner illustrated in FIG. 3.

FIG. 3 illustrates transmission of differential DRCs in CDM according to an exemplary embodiment of the present invention.

FIG. 3 illustrates F1 to F4 for respective channels to denote full DRCs for allocated forward channels FA1 to FA4. D1 to D4 are illustrated for the respective channels to denote differential DRCs for the forward channels FA1 to FA4. In the illustrated case of FIG. 3, the DRCs of the forward channels FA1 to FA4 are delivered on four DRC channels identified by different codes. Each of the DRC channels carries a 4-bit full DRC for a corresponding forward channel in a predetermined slot and differential 1-bit or 2-bit DRCs in the remaining slots in every predetermined period, for example, in every 16 slots.

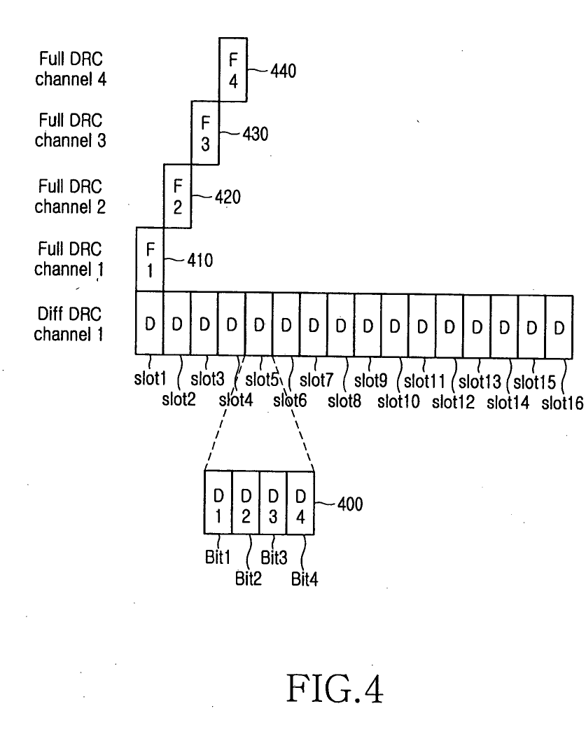

FIG. 4 illustrates transmission of differential DRCs in CDM according to another exemplary embodiment of the present invention.

Referring to FIG. 4, F1 410, F2 420, F3 430 and F4 440 denote full DRCs for allocated forward channels FA1 to FA4, respectively. D1 to D4 400 denote differential DRCs for the forward channels FA1 to FA4, respectively. In the illustrated case of FIG. 4, the 4-bit full DRCs of the forward channels FA1 to FA4 are sent on full DRC channels identified by different codes. Each of the full DRC channels sends a full DRC in a predetermined slot and no information in the remaining slots in every predetermined period, for example, in every 16 slots. In contrast, the 1-bit differential DRCs of the forward channels FA1 to FA4 are sent in the four respective bits 400 on a single DRC channel.

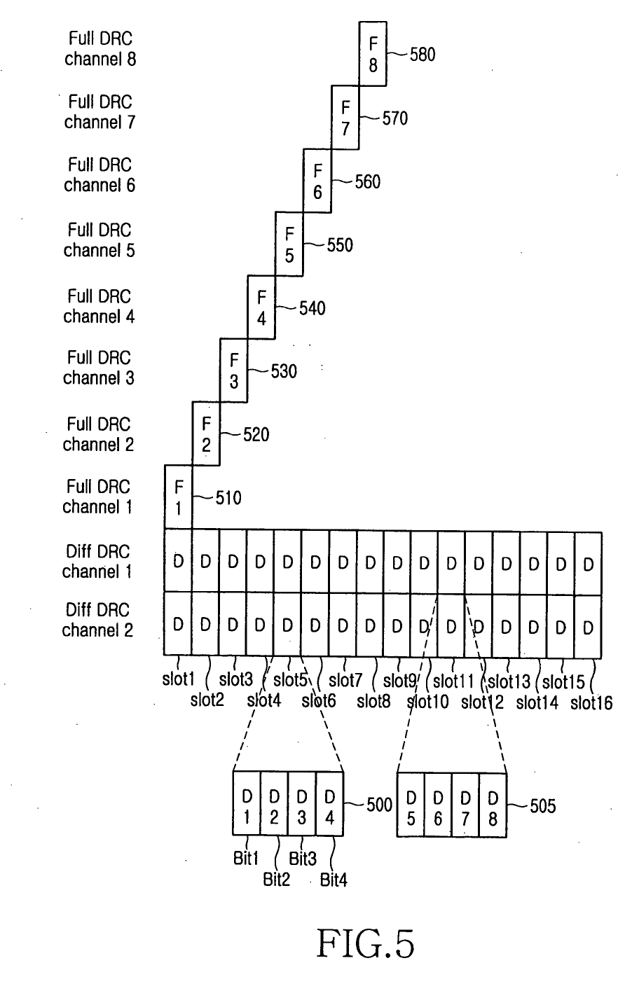

FIG. 5 illustrates reverse DRC channels used when differential DRCs for eight forward channels are sent according to the second exemplary embodiment of the present invention as illustrated in. FIG. 4.

Referring to FIG. 4, 4-bit full DRCs 510 to 580 for eight allocated forward channels are delivered on eight DRC channels identified by different codes. Each of full DRC channels sends a full DRC in a predetermined slot and no information in the remaining slots in every predetermined period, for example, in every 16 slots. In contrast, 1-bit differential DRCs 500 and 505 of the eight forward channels are delivered on two DRC channels, in four respective bits on each of the DRC channels.

Transmission and Reception of Differential DRCs in MS and BS

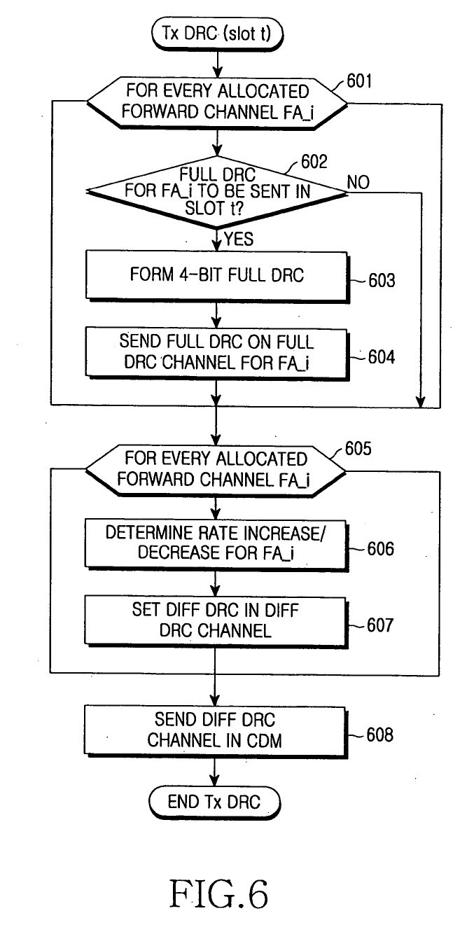

FIG. 6 is a flowchart illustrating an operation for sending differential DRCs in slot t in an MS according to an exemplary embodiment of the present invention.

Referring to FIG. 6, the MS performs steps 602, 603 and 604 for every forward channel allocated in step 601. In step 602, the MS determines whether a full DRC for a forward channel FA_i is to be sent in a current slot t. If it is, the MS creates a 4-bit full DRC for the forward channel FA_i in step 603 and sends the full DRC on a DRC channel for the forward channel FA_i in step 604. As described before, the DRC channel for the forward channel FA_i can be configured to be a TDM DRC channel or a CDM DRC channel distinguished from DRC channels for the other forward channels by a unique code specific to the forward channel FA_i.

In steps 605, 606 and 607, the MS generates and sends differential DRCs for every allocated forward channel. Specifically, the MS sets a differential DRC for the forward channel FA_i to 0 if a data rate supportable for the forward channel FA_i is lower than that of the previous slot t-1. The MS sets a differential DRC to 1 if the data rate supportable for the forward channel FA_i is higher than that in the previous slot t-1. The MS then fills the differential DRC at a predetermined position of a predetermined DRC channel for delivering the differential DRC for the forward channel FA_i in step 607. In FIG. 5, the MS sends a differential DRC for FA 5 in “Bit1” on “Diff DRC Channel 2”. After generating a differential DRC for every allocated forward channel, the MS sends the differential DRCs on DRC channels to the BS in step 608. At this point, the DRC generation and transmission operation is ended.

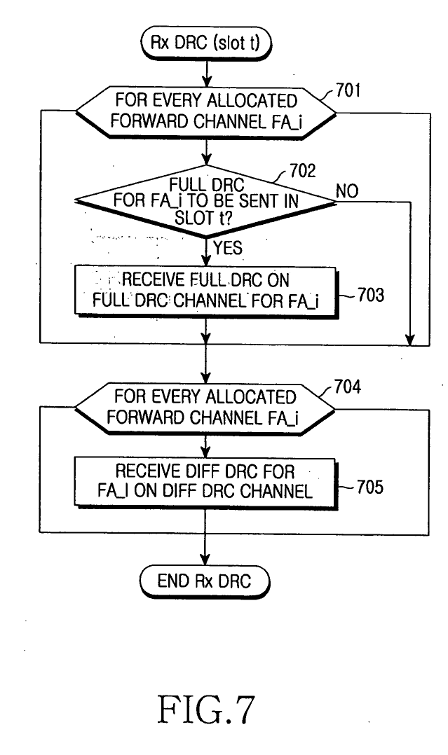

FIG. 7 is a flowchart illustrating an operation for receiving the differential DRCs in slot t from the MS in the BS according to an exemplary embodiment of the present invention.

Referring to FIG. 7, the BS performs steps 702 and 703 for every forward channel allocated to the particular MS. In step 702, the BS determines whether a full DRC for a forward channel FA_i is to be sent by the MS in a current slot t. If it is, the BS receives a predetermined DRC channel which delivers the full DRC of FA_i and checks the full DRC in step 703. As described before, the DRC channel for the forward channel FA_i may be configured to be a TDM DRC channel or a CDM DRC channel distinguished from DRC channels for the other forward channels by a unique code specific to the forward channel FA_i.

In steps 704 and 705, the BS receives a differential DRC for every allocated forward channel from the MS. Specifically, in step 705, the BS can acquire the differential DRC for the forward channel FA_i by receiving bits at a predetermined position on a differential DRC channel. After receiving all full DRCs and differential DRCs from the MS, the BS ends the DRC reception operation.

MS and BS Apparatuses

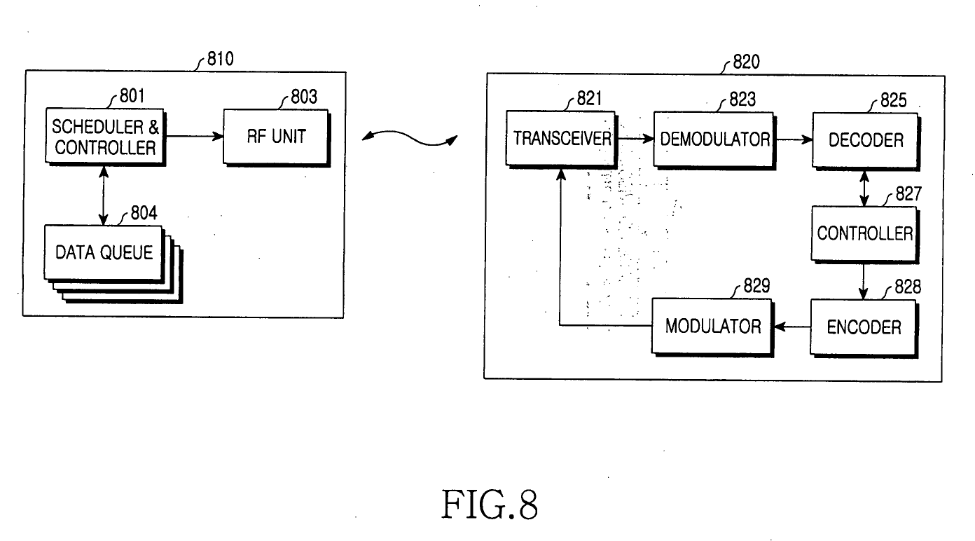

FIG. 8 is a block diagram of the MS and the BS according to an exemplary embodiment of the present invention.

Referring to FIG. 8, a BS apparatus 810 for receiving DRCs includes a scheduler and controller 801, a Radio Frequency (RF) unit 803, and a data queue 804. An MS apparatus 820 for sending the DRCs includes a transceiver 821, a demodulator 823, a decoder 825, a controller 827, an encoder 828, and a modulator 829.

In the BS apparatus 810, the data queue 804 queues data received from an upper node separately for MSs or services. The scheduler and controller 801 selectively control data for a particular user or data of a particular queue. This is done by taking into account DRCs (forward channel status information) received from MSs, service characteristics, and fairness. The RF unit 803 sends the selectively controlled signal to the MS apparatus 820.

In the MS apparatus 820, the demodulator 823 demodulates a signal received from the transceiver 821, the decoder 825 decodes the demodulated signal, and the controller 827 analyzes the decoded signal. Upon generation of data to be transmitted, the encoder 828 encodes the data, the modulator 829 modulates the coded data, and the transceiver 821 sends the modulated data to the BS. To assist scheduling of the BS apparatus 810, the MS apparatus 820 measures the signal strength of a pilot channel received at the transceiver 821 from the BS, determines a data rate at which the MS can receive data from the BS based on the measurement, and reports a DRC indicating the data rate to the BS apparatus 810 through the transceiver 821.

As described above, an exemplary embodiment of the present invention provides a method and apparatus for controlling the data rate of a forward data packet to be received at an MS.

Also, an exemplary embodiment of the present invention facilitates the ability of the MS to send DRCs sufficient times with sufficient accuracy to solve the power consumption problem and facilitates scheduling of data by the BS for the MS in a multi-carrier system.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of transmitting a differential Data Rate Control (DRC) in a multi-frequency mobile communication system, comprising:
transmitting full DRCs for allocated channels based on a multiplexing scheme; and
transmitting differential DRCs for the channels in the multiplexing scheme.

2. The method of claim 1, wherein if the multiplexing scheme comprises Time Division Multiplexing (TDM), full DRCs transmission comprises sequentially transmitting the full DRCs in a first number of slots in a slot period on at least one DRC channel, and differential DRCs transmission comprises transmitting the differential DRCs in the remaining slots.

3. The method of claim 1, wherein the full DRCs transmission comprises transmitting the full DRCs, each in a different slot in a slot period on a DRC channel among a reference number of DRC channels distinguished by different codes, and the differential DRCs transmission comprises transmitting the differential DRCs in slots other than the slots of the full DRCs on at least one of the DRC channels.

4. The method of claim 1, wherein the full DRCs transmission comprises transmitting the full DRCs, each in a different slot in a slot period on a DRC channel among a reference number of DRC channels distinguished by different codes, and the differential DRCs transmission comprises transmitting the differential DRCs on a DRC channel other than the reference number of DRC channels.

5. The method of claim 1, wherein the number of DRC channels for delivering the differential DRCs increases based on the number of DRC channels for delivering the full DRCs.

6. The method of claim 1, wherein the full DRCs transmission comprises:
determining for every allocated channel whether a full DRC is to be transmitted for the channel in a current slot;
generating a 4-bit full DRC for the channel, if the full DRC is to be transmitted in the current slot; and
transmitting the full DRCs for the allocated channels on DRC channels.

7. The method of claim 6, wherein the full DRCs transmission further comprises transmitting a differential DRC for the channel if the full DRC is not to be transmitted in the current slot.

8. The method of claim 1, wherein the differential DRCs transmission comprises:
determining the differential DRCs for the allocated channels according to at least one of a rate increase and a rate decrease supportable for the channels; and
setting the differential DRCs for the allocated channels on DRC channels for delivering the differential DRCs.

9. The method of claim 8, wherein the differential DRCs transmission further comprises transmitting the DRC channels.

10. A method of receiving a differential Data Rate Control (DRC) in a multi-frequency mobile communication system, comprising:
determining for every channel allocated whether a full DRC for the forward channel is to be transmitted in a current slot;
receiving a DRC channel for delivering the full DRC for the channel and checking the full DRC if the full DRC for the channel is to be transmitted in the current slot; and
receiving a differential DRC for the channel from the MS by receiving bits at a position on a differential DRC channel and checking the differential DRC.

11. The method of claim 10, wherein if the full DRC for the channel is not to be transmitted in the current slot, not checking the full DRC.

12. An apparatus for transmitting a differential Data Rate Control (DRC) in a multi-frequency mobile communication system, comprising:
a data processor for generating a full DRC and a differential DRC for at least one allocated channel based on a multiplexing scheme;
a controller for determining whether the full DRC is to be transmitted in a current slot, and determining the differential DRC; and
a transceiver for transmitting a DRC channel containing the full DRC and the differential DRC for the forward channel to a Base Station (BS).

13. The apparatus of claim 12, wherein if the multiplexing scheme comprises Time Division Multiplexing (TDM), full DRCs transmission comprises sequentially transmitting the full DRCs in a first number of slots in a slot period on at least one DRC channel, and differential DRCs transmission comprises transmitting the differential DRCs in the remaining slots.

14. The apparatus of claim 12, wherein the full DRCs transmission comprises transmitting the full DRCs, each in a different slot in a slot period on a DRC channel among a reference number of DRC channels distinguished by different codes, and the differential DRCs transmission comprises transmitting the differential DRCs in slots other than the slots of the full DRCs on at least one of the DRC channels.

15. The apparatus of claim 12, wherein the full DRCs transmission comprises transmitting the full DRCs, each in a different slot in a slot period on a DRC channel among a reference number of DRC channels distinguished by different codes, and the differential DRCs transmission comprises transmitting the differential DRCs on a DRC channel other than the reference number of DRC channels.

16. The apparatus of claim 12, wherein the number of DRC channels for delivering the differential DRCs increases based on the number of DRC channels for delivering the full DRCs.

17. The apparatus of claim 12, wherein the full DRCs transmission comprises:
determining for every allocated channel whether a full DRC is to be transmitted for the channel in a current slot;
generating a 4-bit full DRC for the channel, if the full DRC is to be transmitted in the current slot; and
transmitting the full DRCs for the allocated channels on DRC channels.

18. The apparatus of claim 17, wherein the full DRCs transmission further comprises transmitting a differential DRC for the channel if the full DRC is not to be transmitted in the current slot.

19. The apparatus of claim 12, wherein the differential DRCs transmission comprises:
determining the differential DRCs for the allocated channels according to at least one of a rate increase and a rate decrease supportable for the channels; and
setting the differential DRCs for the allocated channels on DRC channels for delivering the differential DRCs.

20. The apparatus of claim 19, wherein the differential DRCs transmission further comprises transmitting the DRC channels.

21. An apparatus for receiving a differential Data Rate Control (DRC) in a multi-frequency mobile communication system, comprising:
a controller for determining whether a full DRC is to be transmitted in a current slot, and checking a received differential DRC; and
a Radio Frequency (RF) unit for receiving a DRC channel containing the full DRC and the differential DRC.

22. The apparatus of claim 21, wherein if the full DRC for the channel is not to be transmitted in the current slot, not checking the full DRC.

23. A multi-frequency mobile communication system wherein a transmit/receive unit transmits/receives a differential Data Rate Control (DRC), comprising:
a transmit unit for generating a full DRC and a differential DRC for every allocated forward channel, for determining whether the full DRC is to be transmitted in a current slot, for determining the differential DRC, and for transmitting a DRC channel containing the full DRC and the differential DRC for the forward channel to a receive unit; and
a receive unit for determining whether a full DRC is to be transmitted in the current slot by the MS, for checking a received differential DRC, and for receiving a DRC channel containing the full DRC and the differential DRC from the transmit unit.

24. An apparatus for transmitting a differential Data Rate Control (DRC) in a multi-frequency mobile communication system, comprising:
a data processor for generating a full DRC and a differential DRC for at least one allocated channel;
a controller for determining whether the full DRC is to be transmitted in a current slot, and determining the differential DRC;
an RF unit for sending a selectively controlled signal to an MS apparatus;
a data queue for ranking data received from an upper node separately for at least one of an MSs and a service;
a transceiver for transmitting a DRC channel containing the full DRC and the differential DRC for the channel to a Base Station (BS);
a demodulator for demodulating a signal received from the transceiver;
a decoder for decoding the demodulated signal;
an encoder for encoding data once data to be transmitted has been generated; and
a modulator for modulating coded data.

25. The apparatus of claim 24, wherein the BS receives a differential DRC for a channel from the MS by receiving bits at a reference position on a differential DRC channel and verifies the differential DRC.

26. The apparatus of claim 12, wherein the data processor generates a full DRC and a differential DRC for every allocated channel.

27. The apparatus of claim 24, wherein the data processor generates a full DRC and a differential DRC for every allocated channel.
